(19) United States
(12) Patent Application Publication
(10) Pub. No.: US 2026/0141379 A1
(43) Pub. Date: May 21, 2026

(54) MULTI-PARTY THRESHOLDED TRANSACTION APPROVAL IN BLOCKCHAIN SYSTEMS

(71) Applicant: CIRCLE INTERNET GROUP, INC., Boston, MA (US)

(72) Inventors: Ming-Chang SHIH, Kaohsiung (TW); Chi Huang FAN, Taipei (TW); Huai Ting HUANG, Taipei (TW); Wei-Nien SHIH, New Taipei City (TW)

(21) Appl. No.: 18/955,681

(22) Filed: Nov. 21, 2024

(51) Int. Cl. G06Q 20/38; G06Q 20/36

(52) U.S. Cl. CPC G06Q 20/389; G06Q 20/367; G06Q 20/3829

(57) ABSTRACT

Certain aspects of the present disclosure provide techniques for for securely processing transactions on a blockchain or other distributed computing system. An example method generally includes receiving a request to execute an action in the distributed computing system. Based on the request, a set of systems in the distributed computing system are identified to approve the request to execute the action. Generally, each system in the set of systems has a weight associated with the system. Approval is requested from systems in the set of systems for execution of the request to execute the action in the distributed computing system. The action is executed in the distributed computing system based on a cumulative weight of approving systems from the set of systems exceeding a threshold weight for approval.

### INTRODUCTION

Aspects of the present disclosure relate to security in blockchain systems, and more specifically to transaction approval in blockchain systems.

### BACKGROUND

Blockchains can be used in various decentralized systems to provide a ledger of transactions that have occurred within these decentralized systems. Generally, a blockchain may include a chain of blocks, in which latest block includes some information about a transaction that occurred and a reference to an immediate predecessor block, which may be a hashed value of the previous block. Because the reference to the immediate predecessor block may be a value derived from the immediate predecessor block, verification of the transactions in the blockchain may be performed by ensuring that a hash of a block resolves to the same value as that stored as a reference to the immediate predecessor block in a succeeding block in the blockchain. If there is a mismatch between a computed hash of a block and the hashed value of the block in a succeeding block in the blockchain, validation of the blockchain may fail.

To perform transactions on a blockchain system, wallets are generally established for users in order to hold and transfer assets on the blockchain. Generally, wallets on the blockchain are defined based on a private key and a corresponding public key. The public key allows for other users to transfer assets to the wallet. Meanwhile, the private key allows the owner of the wallet to access the contents of the wallet and initiate transactions on the blockchain (e.g., to transfer assets to another wallet, to withdraw assets from the wallet to another blockchain or an external source, etc.).

In some cases, one or more external parties may be used to approve a transaction before the transaction is signed and published on the blockchain (e.g., before a private key is used to sign the transaction, associating the transaction with a specific wallet, and published on the blockchain for verification by nodes participating in processing transactions on the blockchain). The number of parties used to approve a transaction may vary based on properties of the transaction or other action to be performed in a distributed computing system. For example, transactions involving an amount of tokens or other assets on a blockchain below a threshold may be performed based on approval by a number of approving parties in a single stage, while transactions involving an amount of tokens or other assets on a blockchain above the threshold may be performed based on approval by a number of approving parties in each of a plurality of stages.

### BRIEF SUMMARY

Certain embodiments provide a computer-implemented method for securely processing transactions on a blockchain or other distributed computing system. An example method generally includes receiving a request to execute an action in the distributed computing system. Based on the request, a set of systems in the distributed computing system are identified to approve the request to execute the action. Generally, each system in the set of systems has a weight associated with the system. Approval is requested from systems in the set of systems for execution of the request to execute the action in the distributed computing system. The action is executed in the distributed computing system based on a cumulative weight of approving systems from the set of systems exceeding a threshold weight for approval.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example distributed computing environment in which multi-party approval and key recovery is used to approve and sign transactions on a blockchain, according to aspects of the present disclosure.

FIG. 2 depicts an example of multiparty transaction approval and key recovery based on weights associated with nodes in a distributed computing system, according to aspects of the present disclosure.

FIG. 3 illustrates example operations for executing transactions in a distributed computing system based on multi-party approval and key recovery, according to aspects of the present disclosure.

FIG. 4 illustrates an example system on which embodiments of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Transactions in cryptocurrency systems may be represented as blocks in a blockchain that track a universe of transactions performed using the cryptocurrency system. In these cryptocurrency systems, processed transactions may not be modified at a later date, thus providing an immutable ledger of the transactions performed using the cryptocurrency system.

Wallets, defined by a private key and public key pair, generally hold assets, such as native or non-native tokens, that can be transferred on a blockchain. In order to perform a transaction on a blockchain, a user generally signs a transaction using a private key associated with a wallet from which assets are being transferred on the blockchain. That is, a transaction generally identifies the assets to be transferred and the public address (or public key) of the transferee wallet to which these assets are transferred, and the transaction is signed using the private key associated with the transferor wallet. Decrypting the signature of the transaction, using the public key associated with the transferor wallet, allows for the transaction to be verified and thus for assets to be transferred from the transferor wallet to the transferee wallet upon verification of the transaction (e.g., by computing nodes participating in processing transactions on the blockchain).

In some cases, as discussed, transactions may be approved by multiple parties before these transactions are signed and committed to the blockchain, and larger transactions may involve approval by a majority of nodes in each of a plurality of levels in a multi-level approval scheme. However, while multi-party approval of transactions may provide for some degree of security, multi-party approval of transactions may be compromised in a variety of manners. For example, multiple parties can cooperate to approve a transaction; thus, multi-party approval of transactions may be compromised and allow for the approval (and thus commitment to the blockchain) of unauthorized transactions when various parties in a multi-party approval scheme collaborate with a compromised party. In another example, to implement multi-party approval of transactions, a database may be established identifying parties that have approved a transaction. Compromising the database itself may also allow for malicious parties to inject false approval records for a transaction, thus allowing for fraudulent or malicious transactions to be represented as approved when those transactions have not actually been approved by the actual parties that are responsible for approving transactions for execution in a distributed computing system.

Aspects of the present disclosure provide techniques for improving the security of transactions performed in a distributed computing system, such as transactions conducted on a blockchain, using multi-party approval and key recovery techniques based on multi-party approval. Generally, transactions may be output to a set of nodes participating in a multi-party approval scheme for approval, where the set of nodes includes a plurality of subsets of nodes, and each subset of nodes is associated with a portion of a key used to sign a transaction record before the signed record is output to the blockchain. In some aspects, each node may further be associated with a weight metric that can be used to further determine whether a sufficient number of parties have approved a transaction. By doing so, aspects of the present disclosure may distribute signing keys for a transaction across a plurality of nodes or parties, which may minimize, or at least reduce, the risk that fraudulent or malicious transactions are approved and executed in a distributed computing system. For example, because multiple parties may be needed to approve a transaction, the number of parties which need to be compromised in order for a malicious party to execute fraudulent or malicious transactions in a distributed computing system may increase. Further, because approval may be linked to the recovery of portions of a cryptographic key used to sign a transaction, aspects of the present disclosure may allow for the tracking of approvals without the use of a database or other data structure that can be compromised.

### Example Multi-Party Thresholded Transaction Approval in Blockchain Systems

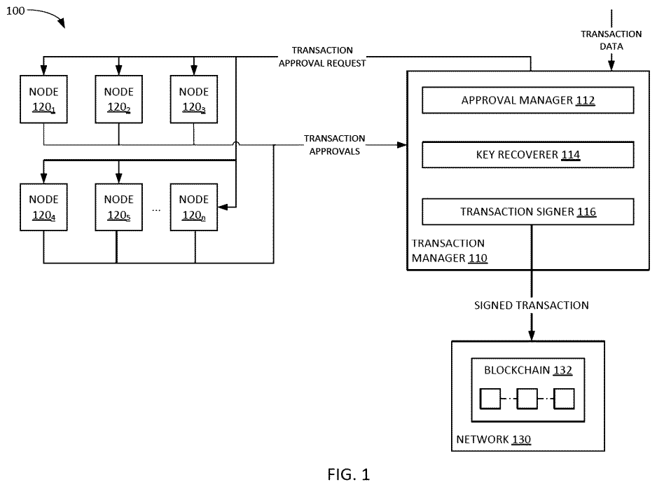

FIG. 1 illustrates an example computing environment 100 in which multi-party approval and key recovery is used to approve and sign transactions on a blockchain. As illustrated, computing environment 100 includes a transaction manager 110, a plurality of nodes 120, and a network 130.

Transaction manager 110 generally receives requests to process incoming transactions, distributes the transactions for approval by nodes in the plurality of nodes 120₁-120ₙ (collectively referred to as “nodes 120”), and determines whether to allow or block execution of a transaction or other request in the computing environment 100. As illustrated, the transaction manager 110 includes an approval manager 112, a key recoverer 114, and a transaction signer 116.

Approval manager 112 generally outputs requests for transaction approval to a plurality of nodes 120 and receives approvals or denials from the plurality of nodes 120. The approval manager 112 may, in some aspects, configure the nodes 120 into a plurality of levels for approval, with each level being associated with a portion of a signing key. In configuring the nodes 120 into a plurality of levels of approval, the approval manager 112 may structure the approval process such that a majority of nodes at each level of the plurality of levels are needed to approve the transaction. For example, in configuring the nodes 120, a cryptographic key or other key used to sign a transaction, decrypt a payload, or otherwise allow for the execution of a transaction may be divided or sharded into a plurality of portions, each portion being associated with nodes in a level of the plurality of levels. Portions of the key, meanwhile, may be divided into a plurality of sub-portions, with each sub-portion being associated with a specific node 120 in specific level of the plurality of levels. In such an example, the key may be recovered when a sufficient number of nodes 120 in each level of the plurality of levels provides approval of the transaction and returns the respective subkey or other key portion associated with the nodes 120 to the approval manager 112 (and, in some aspects, the key recoverer 114).

In some aspects, the nodes 120 may be associated with weights corresponding to an importance of each node 120 to approval of a transaction. Approval manager 112 may track the sum of weights associated with approving nodes 120 at each level of the plurality of levels into which the nodes 120 are organized to determine when a transaction is approved. For example, the approval manager 112 may define a threshold cumulative weight at each level of the plurality of levels, where the threshold cumulative weight corresponds to a minimum cumulative weight associated with the approving nodes 120 that corresponds to approval of a transaction at a given level of the plurality of levels. When the cumulative weights at a level exceed the threshold weight, a sufficient number of nodes 120 may be deemed to have approved the transaction, and the key sub-portions associated with these nodes 120 may be provided to the key recoverer 114 in order to reconstruct the signing key.

In some aspects, assigning weights to each node 120 of the plurality of nodes 120 in the computing environment 100 may allow for certain nodes to be designated as mandatory approval nodes. To do so, a node 120 which is to be designated as a mandatory approval node may be configured with a weight sufficient in size such that the cumulative weight of approving nodes may not reach or exceed the threshold cumulative weight for a level in the plurality of levels. For example, suppose that a level includes four nodes 120₁ through 120₄, with a total weight of 100 and a threshold cumulative weight of 50. In order to make a given node a mandatory node, the weight associated with that node should be greater than 50, as assigning a node a weight equal to the threshold cumulative weight would still allow for the other nodes to approve a transaction if all of the other nodes approved the transaction. Thus, supposing that the node 120₁ is to be designated as the mandatory approval node, node 120₁ may be assigned a weight of at least 51, and the cumulative weights of nodes 120₂, 120₃, and 120₄ may thus add up to 49. In such a case, approval by node 120₁ may be mandatory, and approval of a transaction may further involve approval by at least one of nodes 120₂ through 120₄ to provide sufficient information for the key recoverer 114 to recover the portion of a key associated with the approval layer with which the nodes 120₁ through 120₄ are associated.

In some aspects, multiple nodes 120 in the computing environment 100 may be designated as mandatory approval nodes. To do so, the threshold cumulative weight for approval may be configured such that any subset of the mandatory approval nodes and the remaining nodes in the plurality of nodes are unable to contribute a sufficient weight to reach the threshold cumulative weight. For example, in a level including four nodes 120₁ through 120₄ with nodes 120₁ and 120₂ corresponding to mandatory approval nodes, the nodes 120₃ and 120₄ may have weights set such that the combination of weights of any one mandatory approval node and both nodes 120₃ and 120₄ is less than the threshold. In one example, the threshold cumulative weight may be set to at least a value of 68, and each of the mandatory approval nodes 120₁ and 120₂ may be configured with a weight of 34. The nodes 120₃ and 120₄ may thus have a cumulative weight of 32. In such a case, even if nodes 120₃ and 120₄ approve the transaction, the total cumulative weight of one of the mandatory approval nodes 120₁ or 120₂ and the nodes 120₃ and 120₄ may be equal to 66, which is less than the threshold cumulative weight of 68. It should be recognized, however, that the weights described herein are but examples, and any appropriate combination of weights may be used for the mandatory approval nodes and the other nodes in an approval level.

In some aspects, approval manager 112 can divide the nodes 120 into different arrangements of approval layers. For example, transactions involving a number of tokens under a first threshold amount may be processed using nodes divided into a first number of layers; transactions involving a number of tokens over the first threshold amount and under a second threshold amount may be processed using nodes divided into a second number of layers greater than the first number of layers; and so on. By doing so, aspects of the present disclosure may increase the number of nodes 120 which are needed in order to approve execution of a transaction or other operation in the computing environment 100 based on the size of the transaction. In some aspects, nodes 120 in the computing environment 100 may be included in some layers but not in other layers. That is, the first number of layers may include a subset of nodes 120 in the computing environment 100, the second number of layers may include a larger subset of nodes 120 in the computing environment 100, and so on.

Key recoverer 114 uses the key data returned by the approving nodes 120 to reconstruct a signing key used to sign transactions on the blockchain 132. The signing key, which may correspond to a private key of a wallet associated with transactions on the blockchain, may be a cryptographic key that is distributed across the plurality of nodes 120 based on mathematical division (or sharding) of the key. The number of portions (or shards) of the signing key may be equal to the number of approval levels into which the nodes 120 are organized. Within each level of the plurality of approval levels, the portion of the signing key associated with the level may further be divided (or sharded) into a plurality of partitions corresponding to the number of nodes 120 associated with that level.

To recover the signing key used by the transaction signer 116 to sign a transaction record and commit the signed transaction record to the blockchain 132, the key recoverer 114 obtains key sub-portions from each of the nodes 120 that have provided approval of a transaction to the transaction manager 110. Within each level of the plurality of approval levels (which, as discussed above, is associated with a subkey), a number of sub-portions may be established, with the number of sub-portions associated with the subkey being associated with the number of nodes 120 in the approval level. Further, a threshold number of sub-portions may be established for each subkey, with the threshold number defining the minimum number of nodes 120 that are needed for transaction approval and subkey reconstruction. The threshold number may be, in some aspects, smaller than the total number of nodes 120 associated with the level in the plurality of approval levels.

When a sufficient number of nodes 120 at a threshold number of levels in the plurality of approval levels have approved a transaction and provided the portions of a signing key needed to recover the signing key, the key recoverer 114 recovers the signing key. The signing key may then be provided to the transaction signer 116 along with the information about the transaction to be executed in the computing environment 100. A transaction record may be generated based on the information about the transaction received at the transaction manager 110, and the transaction record may be signed using the signing key. Subsequently, the signed transaction record can be broadcast to nodes associated with the blockchain 132 for verification. When the transaction is verified, the signed transaction record may be published on the blockchain 132, which immutably commits the transaction to the blockchain 132.

Network 130 may, in some aspects, be a cryptocurrency network for which transaction manager 110 processes transactions. By way of example, network 130 may be a network such as ALGORAND™, BITCOIN™, ETHEREUM®, SOLANA™, STELLAR™, and other cryptocurrency networks. Transactions on a blockchain 132 hosted by network 130 may include, for example, the execution of one or more smart contracts on the blockchain 132 or by the generation of one or more blocks on the blockchain evidencing the occurrence of a transaction on the blockchain 132.

### Example Hierarchical Multi-Party Thresholded Transaction Approval

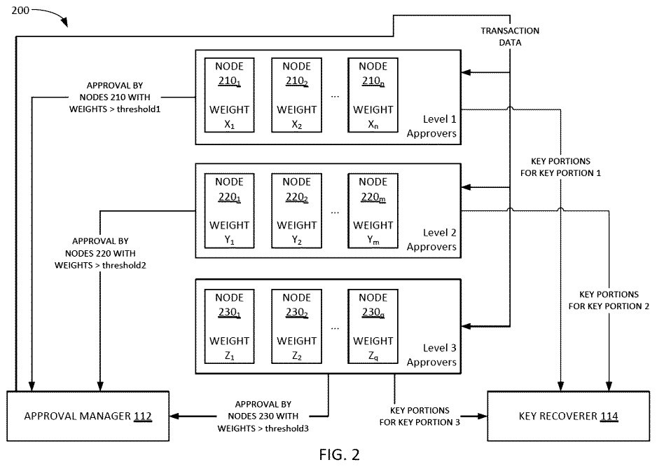

FIG. 2 illustrates an example 200 of hierarchical multi-party threshold transaction approval for approving transactions to be performed on a blockchain (e.g., the blockchain 132 illustrated in FIG. 1), according to aspects of the present disclosure.

In the example 200, the nodes 210, 220, and 230 (amongst others not illustrated in FIG. 2, each of which may correspond to a node 120 illustrated in FIG. 1) may be distributed into a plurality of approval levels. The nodes 210₁, 210₂, 210ₙ (collectively “nodes 210”) may be assigned to level 1 in the plurality of approval levels; the nodes 220₁, 220₂, 220ₘ (collectively “nodes 220”) may be assigned to level 2 in the plurality of approval levels, and the nodes 230₁, 230₂, 230_{q} may be assigned to level 3 in the plurality of approval levels. Each of the nodes 210, 220, and 230 may, as illustrated have a weight assigned to each node. The weight assigned to a node may generally represent an importance assigned to a node in approving a transaction and thus allowing for a signing key (or portion thereof) to be recovered by the key recoverer 114. As discussed, these weights may be set such that a node is deemed a mandatory approval node in a particular approval layer in which the nodes 210, 220, and 230 (amongst others) are assigned. Generally, when a node is to be deemed a mandatory approval node in an approval layer, the weight assigned to that node may be set such that the cumulative weight of other nodes in the approval layer is less than the threshold (e.g., threshold1 for nodes in level 1 of the plurality of approval levels, threshold2 for nodes in level 2 of the plurality of approval levels, threshold3 for nodes in level 3 of the plurality of approval levels, and so on).

To approve a transaction and provide portions of a cryptographic key that can be used reconstruct the signing key for use in signing a transaction record associated with the transaction, transaction data may be included in an approval request distributed to nodes in one or more levels of the plurality of approval levels. While FIG. 2 illustrates the distribution of approval requests and transaction data to each level illustrated in FIG. 2, it should be recognized that the approval manager 112 can distribute the transaction data and approval requests to nodes in any number of levels in the plurality of approval levels. For example, as discussed, different numbers of approval levels can be used for transactions involving different amounts of tokens or other assets in a distributed computing system, with transactions involving larger amounts of tokens or other assets being associated with more approval layers than transactions involving smaller amounts of tokens or other assets.

Generally, for a transaction to be approved at a given level in the plurality of approval levels, a sufficient number of nodes are to provide approval, and in aspects in which a weight is assigned to each node in an approval level, the cumulative weight of the nodes that have provided approval of the transaction is to exceed a threshold weight. For example, out of the n nodes 210 in level 1 of the plurality of approval levels, the number of nodes that are to provide approval of a transaction should exceed a threshold number that may be defined a priori. The threshold number may, for example, specify that at least half of the n nodes 210 in level 1 of the plurality of approval levels are to signal approval of the transaction in order for the transaction to be approved at level 1. Further, as illustrated, in order for the transaction to be approved, the nodes 120, having weights X₁ through Xₙ, that have provided their approval of the transaction should have a cumulative weight exceeding a first threshold weight. Similarly, at level 2 of the plurality of approval levels, a threshold number of the m nodes 220 in level 2 are to signal approval of the transaction in order for the transaction to be approved at level 2, and where (as illustrated) weights Y₁ thorugh Yₘ are assigned to the m nodes 220, the nodes 220 that have provided approval should have a cumulative weight exceeding a second threshold weight. Finally, at level 3 of the plurality of approval levels, a threshold number of the q nodes 230 in level 3 are to signal approval of the transaction in order for the transaction to be approved at level 3, and where (as illustrated) weights Z₁ thorugh Z_{q} are assigned to the q nodes 230, the nodes 230 that have provided approval should have a cumulative weight exceeding a third threshold weight.

In some aspects, the transaction data and approval requests may be output to the nodes 210, 220, 230, and others for processing in parallel. Approvals may be received at the approval manager from the nodes 210, 220, 230 asynchronously, and, as discussed, when a sufficient number of approvals have been received, the transaction may be deemed to have been approved and may be output to a transaction signer for signing. In some aspects, the transaction data and approval requests may be output to nodes in different approval levels sequentially. In such a case, for example, the transaction data and approval requests may be first output to the nodes 210 in level 1 of the plurality of approval levels. After a sufficient number of nodes in level 1, with a cumulative weight exceeding the first threshold weight, have signaled approval of the transaction to the approval manager 112, the transaction data and approval requests may be output to the nodes 220 in level 2 of the plurality of approval levels. Likewise, after a sufficient number of nodes in level 2 have signaled approval of the transaction, with the cumulative weight of the approving nodes exceeding the second threshold weight, the transaction data and approval requests may be output to the nodes 230 in level 3 of the plurality of approval levels. This sequential approval scheme may continue with each level in the plurality of approval levels until approval has been received from nodes in a sufficient number of approval levels.

In some aspects, portions of a signing key or subkey may be transmitted by the approving nodes to the key recoverer 114 to recover the signing key. As discussed, the signing key may be divided (or sharded) into a plurality of key portions, with each key portion being associated with a level in the plurality of approval levels. Each key portion may in turn be divided into a plurality of sub-portions, with each sub-portion being associated with a node in a specific approval level. To recover the signing key, a sufficient number of key sub-portions from each level in the plurality of approval levels may need to be returned to the key recoverer 114 from the nodes 210, 220, 230 (amongst others). As discussed, the number of key sub-portions needed to recover a key portion associated with a level may be defined on a per-level basis based, for example, based on a number of nodes in the layer of the plurality of approval layers, a number of nodes that are to provide key sub-portions in order to recover the key portion, and the like. When a sufficient number of nodes have returned key sub-portions such that each key portion can be recovered, the signing key can be recovered as well based on the recovery of the key portions associated with the levels in the plurality of approval levels.

When the approval manager 112 receives approval of the transaction from a sufficient number of parties, an approval lock on the transaction may be released, and the transaction data may be released to a transaction signer (e.g., the transaction signer 116 illustrated in FIG. 1). After the signing key is recovered based on the key sub-portions provided to the key recoverer 114, the signing key may be output to the transaction signer, and the transaction signer can subsequently sign a transaction record and execute the transaction (e.g., publish the transaction to the blockchain, invoke a smart contract specified in the transaction record to effectuate a transaction on the blockchain, etc.).

### Example Operations for Multi-Party Thresholded Transaction Approval and Execution in Blockchain Systems

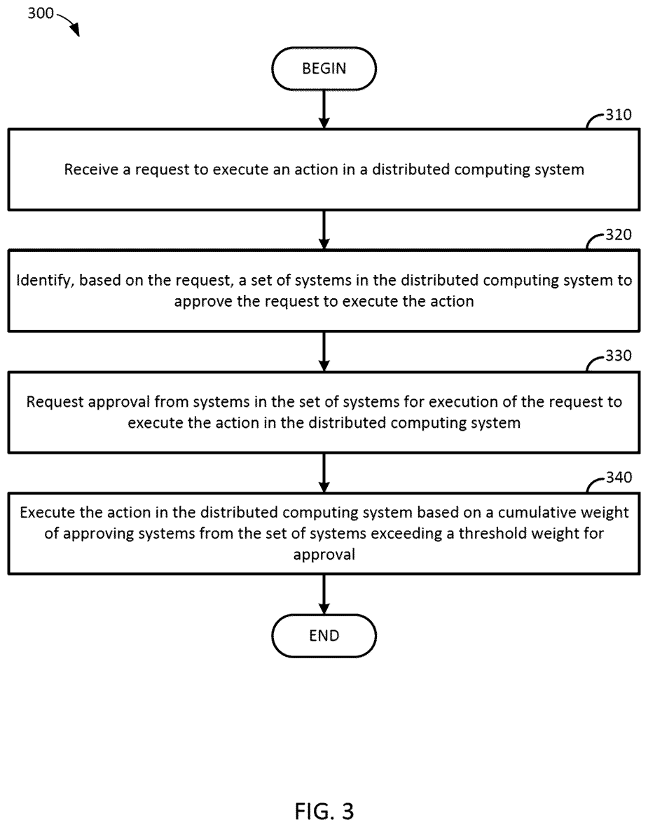

FIG. 3 illustrates example operations 300 for executing transactions in a distributed computing system based on multi-party approval and key recovery. The operations 300 may be performed, for example, by a transaction manager, such as the transaction manager 110 illustrated in FIG. 1 or other computing system that can track approval of a transaction from a plurality of nodes in a distributed computing system and reconstruct a signing key for a transaction based on key portions provided by nodes in the distributed computing system.

As illustrated, the operations 300 begin at block 310, with receiving a request to execute an action in the distributed computing system;

At block 320, the operations 300 proceed with identifying, based on the request, a set of systems in the distributed computing system to approve the request to execute the action. Generally, each system in the set of systems is associated with a weight. The weight may be assigned to each system a priori.

In some aspects, a weight associated with a system in the set of systems is associated with an importance of the system to approval of the request.

In some aspects, the set of systems comprises a plurality of subsets of systems, each respective subset of systems being associated with a respective threshold weight to be satisfied for approval. For example, as discussed, the plurality of subsets of systems may correspond to the different levels in the plurality of approval levels that are used to approve execution of a transaction in the distributed computing system (e.g., the blockchain). For each subset of systems, corresponding to a specific approval level of the plurality of approval levels, the systems in the subset of systems may have a priori defined weights, and the cumulative weight of the approving systems in the subset of systems may be compared to the threshold weight for the subset of systems to determine whether or not a transaction may be deemed to have been approved. In some aspects, the threshold weight and a weight associated with one or more systems in the set of systems may be used to identify systems as mandatory approval parties in a multi-party transaction approval scheme. Generally, as discussed, the threshold weight and the weight associated with the systems identified as mandatory approval parties may be set such that each of the systems identified as mandatory approval parties are needed to approve a transaction and systems other than the systems identified as mandatory approval parties cannot approve the transaction without the systems identified as mandatory approval parties also approving the transaction.

At block 330, the operations 300 proceed with requesting approval from systems in the set of systems for execution of the request to execute the action in the distributed computing system.

At block 340, the operations 300 proceed with executing the action in the distributed computing system based on a cumulative weight of approving systems from the set of systems exceeding a threshold weight for approval.

In some aspects, executing the action in the distributed computing system includes recovering a signing key for signing a transaction record committed to a blockchain based on the approving systems from the set of systems. Generally, the signing key may be recovered based on key portions or sub-portions associated with the approving systems from the set of systems. For example, as discussed, each system in the set of systems may be associated with a key sub-portion which may be returned to the transaction manager when a system signals its approval of a transaction. When a threshold number of nodes have signaled approval of the transaction, a sufficient number of key portions or sub-portions may be available at a key recoverer for recovery of the signing key. In some aspects, as discussed above, the signing key may be recovered on a per-key-portion basis, with each portion corresponding to a set of nodes in a level from a plurality of approval levels into which the systems are organized. In such a case, each portion of the signing key may be recovered based on the key sub-portions associated with the key, with the portion of the signing key being recovered when an a priori defined number of key sub-portions have been returned from the systems to the transaction manager. A record associated with the request may be signed based on the signing key, and the record associated with the request may be committed to the blockchain.

In some aspects, executing the action in the distributed computing system comprises determining that a cumulative weight for approving systems from each respective subset of systems exceeds the respective threshold weight associated with the respective subset of systems.

In some aspects, each respective subset of systems is associated with a portion of a cryptographic key for signing a transaction record on a blockchain.

In some aspects, the operations 300 further include recovering portions of the cryptographic key based on recovery of sub-keys associated with one or more subsets of systems from the plurality of subsets of systems. The cryptographic key may be recovered based on the recovered portions of the cryptographic key.

### Example System for Multi-Party Thresholded Transaction Approval and Execution in Blockchain Systems

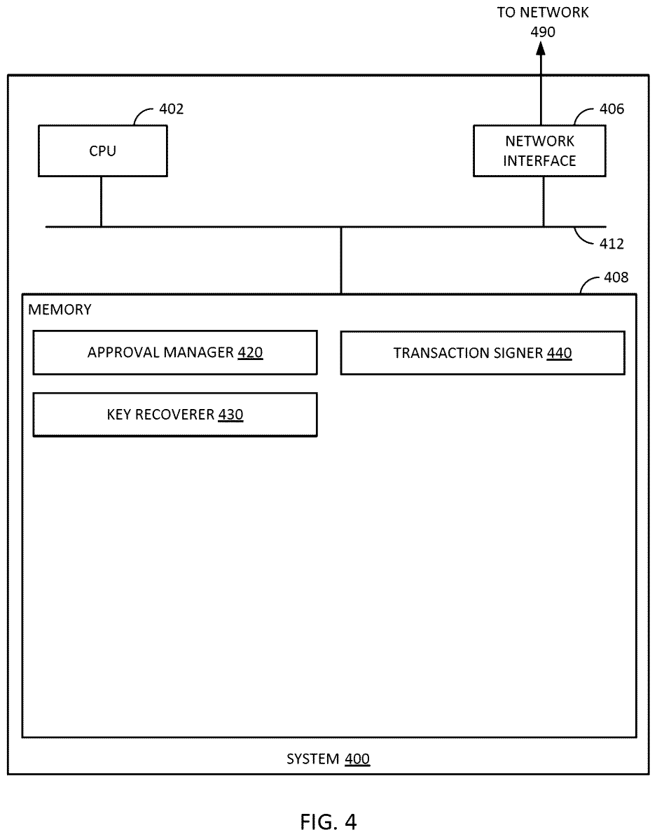

FIG. 4 illustrates an example system 400 configured to perform the methods described herein, including, for example, operations 300 illustrated in FIG. 3. In some embodiments, system 400 may act as a transaction manager through which transaction approval is requested and obtained from a plurality of nodes (e.g., nodes 120 illustrated in FIG. 1 and/or nodes 210, 220, 230 illustrated in FIG. 2) and a transaction is signed based on a cryptographic key recovered from the plurality of nodes, such as transaction manager 110 illustrated in FIG. 1.

As shown, system 400 includes a central processing unit (CPU) 402, network interface 406 through which system 400 is connected to network 490 (which may be a local network, an intranet, the internet, or any other group of computing devices communicatively connected to each other), a memory 408, and an interconnect 412. The network interface 406 may be used to receive requests to upgrade bridged tokens on a blockchain to native tokens on the blockchain (e.g., as depicted and described with respect to FIGS. 1 through 3.

CPU 402 may retrieve and execute programming instructions stored in the memory 408. Similarly, the CPU 402 may retrieve and store application data residing in the memory 408. The interconnect 412 transmits programming instructions and application data, among the CPU 402, network interface 406, and memory 408.

CPU 402 is included to be representative of a single CPU, multiple CPUs, a single CPU having multiple processing cores, and the like.

Memory 408 is representative of a volatile memory, such as a random access memory, or a nonvolatile memory, such as nonvolatile random access memory, phase change random access memory, or the like. As shown, memory 408 includes an approval manager 420, a key recoverer 430, and a transaction signer 440.

Approval manager 420 generally corresponds to approval manager 112 illustrated in FIG. 1. Generally, approval manager 420 receives a request to execute a transaction or other operation in a distributed computing environment and requests approval of the transaction from a plurality of nodes external to the system 400 (e.g., by transmitting one or more messages including information about the transaction and an approval request to the nodes via network interface 406). Approval manager 420 generally tracks approvals received from the nodes to determine when a sufficient number of nodes have approved a transaction. Approval manager 420 may also track the weights of the approving nodes to determine whether nodes with a sufficient weight have approved the transaction. In some aspects, approval of a transaction may be performed based on approvals received from nodes organized into a plurality of approval layers. Approval manager 420 may track approvals on a per-layer basis to determine whether a sufficient number of nodes in each layer having a sufficient weight have signaled approval of the transaction.

Key recoverer 430 generally recovers a signing key used by the transaction signer 440 to sign a transaction and execute the signed transaction in a distributed computing environment. Generally, key recoverer 430 receives, from nodes external to the system 400 (e.g., via messaging including key portions received on network interface 406) portions of a signing key, which may be a private key associated with a wallet with which transactions on the blockchain may be associated, and recovers the signing key based on the received portions of the signing key. In some aspects, the key recoverer 430 can recover keys on a per-portion basis, with each portion being associated with nodes in a different layer from a plurality of approval layers. When a sufficient number of systems have provided approval of the transaction and returned their respective key sub-portion to the key recoverer 430, the key recoverer 430 can recover a key portion based on the key sub-portions returned by the nodes in the layer of the plurality of approval layers associated with the key portion.

Transaction signer 440 generally corresponds to transaction signer 116 illustrated in FIG. 1. Generally, transaction signer 440 uses approval of the transaction determined by the approval manager 420 and a signing key recovered by key recoverer 430 to sign a transaction record associated with the transaction for which approval was received by approval manager 420. In some aspects, transaction signer 440 may use the signing key recovered by key recoverer 430 to grant or obtain access to digital assets stored in the wallet associated with the wallet private key, sign transaction records evidencing the transfer of digital assets from the wallet associated with the wallet private key to a recipient wallet, and the like. After the transaction record is signed, the signed transaction may be may be published (e.g., via network interface 506) on a blockchain (e.g., on network 590, and which, as discussed, may provide an immutable ledger in which transactions are recorded and may not be reversed or changed) for further processing.

### Example Clauses

Implementation details for various aspects of the present disclosure are described in the following numbered clauses.

Clause 1: A processor-implemented method for securing transactions in a distributed computing system, comprising: receiving a request to execute an action in the distributed computing system; identifying, based on the request, a set of systems in the distributed computing system to approve the request to execute the action, each system in the set of systems having a weight; requesting approval from systems in the set of systems for execution of the request to execute the action in the distributed computing system; and executing the action in the distributed computing system based on a cumulative weight of approving systems from the set of systems exceeding a threshold weight for approval.

Clause 2: The method of Clause 1, wherein executing the action in the distributed computing system comprises: recovering a signing key for signing a transaction record committed to a blockchain based on the approving systems from the set of systems; signing a record associated with the request based on the signing key; and committing the record associated with the request to the blockchain.

Clause 3: The method of any one of Clauses 1 or 2, wherein a weight associated with a system in the set of systems is associated with an importance of the system to approval of the request.

Clause 4: The method of any one of Clauses 1 through 3, wherein the action comprises a transfer of tokens from a first cryptocurrency wallet to a second cryptocurrency wallet, and wherein the method further comprises determining the threshold weight for approval based on number of tokens to be transferred from the first cryptocurrency wallet to the second cryptocurrency wallet.

Clause 5: The method of any one of Clauses 1 through 4, wherein the set of systems comprises a plurality of subsets of systems, each respective subset of systems being associated with a respective threshold weight to be satisfied for approval.

Clause 6: The method of Clause 5, wherein each respective subset of systems is associated with a portion of a cryptographic key for signing a transaction record on a blockchain.

Clause 7: The method of Clause 6, further comprising: recovering portions of the cryptographic key based on recovery of sub-keys associated with one or more subsets of systems from the plurality of subsets of systems; and recovering the cryptographic key based on the recovered portions of the cryptographic key.

Clause 8: The method of any one of Clauses 5 through 7, wherein executing the action in the distributed computing system comprises determining that a cumulative weight for approving systems from each respective subset of systems exceeds the respective threshold weight associated with the respective subset of systems.

Clause 9: The method of any one of Clauses 5 through 8, wherein requesting approval from systems in the set of systems for execution of the request to execute the action in the distributed computing system comprises sequentially requesting approval from each subset of systems.

Clause 10: A system, comprising: a memory having executable instructions stored thereon; and a processor configured to execute the executable instructions to perform the operations of any one of Clauses 1 through 9.

Clause 11: A system, comprising: means for performing the operations of any one of Clauses 1 through 9.

Clause 12: A computer-readable medium having instructions stored thereon which, when executed by a processor, performs the operations of any one of Clauses 1 through 9.

### Additional Considerations

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A processor-implemented method, comprising:
receiving a request to execute a transaction on a blockchain;
identifying, based on the request, a set of systems in the blockchain to approve the request to execute the transaction, each system in the set of systems having a weight corresponding to a particular level of a plurality of approval levels that is assigned to the system;
requesting approval from systems in the set of systems for execution of the request to execute the transaction on the blockchain; and
executing the transaction on the blockchain based on a cumulative weight of approving systems from the set of systems exceeding a threshold weight for approval.

2. The method of claim 1, wherein executing the transaction on the blockchain comprises:
recovering a signing key for signing a transaction record committed to the blockchain based on the approving systems from the set of systems;
signing a record associated with the request based on the signing key; and
committing the record associated with the request to the blockchain.

3. The method of claim 1, wherein a weight associated with a system in the set of systems is associated with an importance of the system to approval of the request.

4. The method of claim 1, wherein the transaction comprises a transfer of tokens from a first cryptocurrency wallet to a second cryptocurrency wallet, and wherein the method further comprises determining the threshold weight for approval based on number of tokens to be transferred from the first cryptocurrency wallet to the second cryptocurrency wallet.

5. The method of claim 1, wherein the set of systems comprises a plurality of subsets of systems, each respective subset of systems being associated with a respective threshold weight to be satisfied for approval.

6. The method of claim 5, wherein each respective subset of systems is associated with a portion of a cryptographic key for signing a transaction record on the blockchain.

7. The method of claim 6, further comprising:
recovering portions of the cryptographic key based on recovery of sub-keys associated with one or more subsets of systems from the plurality of subsets of systems; and
recovering the cryptographic key based on the recovered portions of the cryptographic key.

8. The method of claim 5, wherein executing the transaction on the blockchain comprises determining that a cumulative weight for approving systems from each respective subset of systems exceeds the respective threshold weight associated with the respective subset of systems.

9. The method of claim 5, wherein requesting approval from systems in the set of systems for execution of the request to execute the transaction on the blockchain comprises sequentially requesting approval from each subset of systems.

10. A processing system, comprising:
at least one memory having executable instructions stored thereon; and
one or more processors configured to execute the executable instructions to cause the processing system to:
receive a request to execute a transaction on a blockchain;
identify, based on the request, a set of systems in the blockchain to approve the request to execute the transaction, each system in the set of systems having a weight corresponding to a particular level of a plurality of approval levels that is assigned to the system;
request approval from systems in the set of systems for execution of the request to execute the transaction on the blockchain; and
execute the transaction on the blockchain based on a cumulative weight of approving systems from the set of systems exceeding a threshold weight for approval.

11. The processing system of claim 10, wherein to execute the transaction on the blockchain, the one or more processors are configured to cause the processing system to:
recover a signing key for signing a transaction record committed to the blockchain based on the approving systems from the set of systems;
sign a record associated with the request based on the signing key; and
commit the record associated with the request to the blockchain.

12. The processing system of claim 10, wherein a weight associated with a system in the set of systems is associated with an importance of the system to approval of the request.

13. The processing system of claim 10, wherein the transaction comprises a transfer of tokens from a first cryptocurrency wallet to a second cryptocurrency wallet, and wherein the one or more processors are further configured to cause the processing system to determine the threshold weight for approval based on number of tokens to be transferred from the first cryptocurrency wallet to the second cryptocurrency wallet.

14. The processing system of claim 10, wherein the set of systems comprises a plurality of subsets of systems, each respective subset of systems being associated with a respective threshold weight to be satisfied for approval.

15. The processing system of claim 14, wherein each respective subset of systems is associated with a portion of a cryptographic key for signing a transaction record on the blockchain.

16. The processing system of claim 15, wherein the one or more processors are further configured to cause the processing system to:
recover portions of the cryptographic key based on recovery of sub-keys associated with one or more subsets of systems from the plurality of subsets of systems; and
recover the cryptographic key based on the recovered portions of the cryptographic key.

17. The processing system of claim 14, wherein to execute the transaction on the blockchain, the one or more processors are configured to cause the processing system to determine that a cumulative weight for approving systems from each respective subset of systems exceeds the respective threshold weight associated with the respective subset of systems.

18. The processing system of claim 14, wherein to request approval from systems in the set of systems for execution of the request to execute the transaction on the blockchain, the one or more processors are configured to cause the processing system to sequentially request approval from each subset of systems.

19. A computer-readable medium having executable instructions stored thereon which, when executed by one or more processors, performs an operation comprising:
receiving a request to execute a transaction on a blockchain;
identifying, based on the request, a set of systems in the blockchain to approve the request to execute the transaction, each system in the set of systems having a weight corresponding to a particular level of a plurality of approval levels that is assigned to the system;
requesting approval from systems in the set of systems for execution of the request to execute the transaction on the blockchain; and
executing the transaction on the blockchain based on a cumulative weight of approving systems from the set of systems exceeding a threshold weight for approval.

20. The computer-readable medium of claim 19, wherein executing the transaction on the blockchain comprises:
recovering a signing key for signing a transaction record committed to the blockchain based on the approving systems from the set of systems;
signing a record associated with the request based on the signing key; and
committing the record associated with the request to the blockchain.

21. The computer-readable medium of claim 19, wherein a weight associated with a system in the set of systems is associated with an importance of the system to approval of the request.

22. The computer-readable medium of claim 19, wherein the transaction comprises a transfer of tokens from a first cryptocurrency wallet to a second cryptocurrency wallet, and wherein the method further comprises determining the threshold weight for approval based on number of tokens to be transferred from the first cryptocurrency wallet to the second cryptocurrency wallet.

23. The computer-readable medium of claim 19, wherein the set of systems comprises a plurality of subsets of systems, each respective subset of systems being associated with a respective threshold weight to be satisfied for approval.

24. The computer-readable medium of claim 23, wherein each respective subset of systems is associated with a portion of a cryptographic key for signing a transaction record on the blockchain.

25. The computer-readable medium of claim 24, further comprising:
recovering portions of the cryptographic key based on recovery of sub-keys associated with one or more subsets of systems from the plurality of subsets of systems; and
recovering the cryptographic key based on the recovered portions of the cryptographic key.

26. The computer-readable medium of claim 23, wherein executing the transaction on the blockchain comprises determining that a cumulative weight for approving systems from each respective subset of systems exceeds the respective threshold weight associated with the respective subset of systems.

27. The computer-readable medium of claim 23, wherein requesting approval from systems in the set of systems for execution of the request to execute the transaction on the blockchain comprises sequentially requesting approval from each subset of systems.
